(19) United States
(12) Patent Application Publication
(10) Pub. No.: US 2026/0348427 A1
(43) Pub. Date: Nov. 5, 2026

(54) BALL STRUCTURE FOR HOSE REEL BRACKET

(71) Applicant: Hangzhou Jutu E-commerce Co., Ltd., Hangzhou (CN)

(72) Inventor: Bohao LIN, Jinhua (CN)

(21) Appl. No.: 19/709,253

(22) Filed: Jun. 16, 2026

(30) Foreign Application Priority Data
Apr. 22, 2026 (CN) 202620545394.7

(51) Int. Cl. F16C 19/06; B65H 75/44; F16C 33/66

(52) U.S. Cl. CPC F16C 19/06; B65H 75/4471; F16C 33/6651; B65H 2701/33; F16C 2314/00

(57) ABSTRACT

Provided is a ball structure for a hose reel bracket. The structure includes a bracket and a hose reel. The bracket is integrally formed with four evenly distributed ball grooves, each of which is provided with an oil storage tank and three POM material balls with a diameter of 8 millimeters. The balls are fixed by a fixing component consisting of a PP plastic ball cover and two screws, the ball cover can be opened for maintenance. A bottom of the hose reel is in contact with the balls and does not directly contact the bracket. When rotating, the balls rotate in coordination and convert a sliding friction into a rolling friction, thereby reducing the friction force to 1/40 to 1/60 of an original sliding friction. This structure balances firmness and flexibility, is wear-resistant, durable, and easy to maintain, and is suitable for the use of heavy-loading hose reels.

### CROSS-REFERENCE TO RELATED APPLICATIONS

This application claims priority to Chinese Patent Application No. 202620545394.7, filed on Apr. 22, 2026, which is hereby incorporated by reference in its entirety.

### TECHNICAL FIELD

The present disclosure relates to the field of hose reel technologies, and in particular, to a ball structure for a hose reel bracket, which is used to solve problems of high rotational friction resistance, insufficient flexibility, and difficulty in balancing firmness between existing hose reels and brackets.

### BACKGROUND

In the current field of hose reels, they are usually fixed on different forms of brackets to achieve rotation function, and the two will generate mutual friction during a rotation process. As the weight of the hose reel increases, the frictional resistance between it and the bracket will also increase, resulting in a corresponding decrease in rotational flexibility and affecting the use experience.

At present, the conventional solution to solve the above problems in the same industry is to reduce the contact area between the hose reel and the bracket to reduce friction and improve rotational flexibility. However, this scheme has obvious drawbacks: on the one hand, the reduction in contact area will lead to a decrease in the firmness of the connection between the hose reel and the bracket, affecting the stability of the structure; on the other hand, this scheme still belongs to the category of sliding friction, with limited reduction in friction force, and the improvement effect of rotational flexibility has not reached the expected effect, which cannot meet the needs of heavy-loading hose reels.

### SUMMARY

The purpose of the present disclosure is to provide a ball structure for a hose reel bracket, which converts a sliding friction between a hose reel and a bracket into a rolling friction. While ensuring structural stability, it significantly reduces frictional resistance, improves rotational flexibility, and has good maintainability and durability. The ball structure includes a bracket and a hose reel, and the bracket is integrally provided with ball grooves, and the ball grooves are provided with balls and fixed by a fixing component; a bottom of the hose reel is in contact with the balls and does not directly connect the bracket. When rotating, the balls rotate in cooperation and convert the sliding friction into the rolling friction, thereby reducing a friction force to 1/40 to 1/60 of an original sliding friction. The integrated ball grooves ensure the structural strength of the bracket.

In some embodiments of the present disclosure, there are four ball grooves evenly distributed along a circumference of the bracket, thereby ensuring uniform force distribution during the rotation of the hose reel and improving rotational stability.

In some embodiments of the present disclosure, each of the ball grooves is provided with an oil storage tank for storing lubricating oil, thereby avoiding rapid loss of lubricating oil, achieving continuous lubrication of the balls, and reducing friction loss.

In some embodiments of the present disclosure, three balls with a diameter of 8 millimeters are provided in each of the ball grooves, this diameter is arranged to balance the bearing capacity and rotational flexibility of the balls and adapt to the rotation requirements of the hose reel.

In some embodiments of the present disclosure, the balls are made of POM (polyoxymethylene) material, which has good wear resistance, toughness, and self-lubricating properties, which can reduce the friction loss of the balls themselves and improve durability.

In some embodiments of the present disclosure, the fixing component includes a PP (polypropylene) plastic ball cover and two screws. The ball cover is fixed to the bracket by the screws and limits the balls, thereby preventing the balls from detaching without affecting its normal rotation. The PP plastic material has characteristics of lightweight and corrosion resistance.

In some embodiments of the present disclosure, the ball cover can be opened for a user to add lubricating oil for maintenance or replace worn balls, thereby improving the maintainability of the structure and extending its overall service life.

Compared with the existing technology, the present disclosure has the following beneficial effects:
1. significant reduction in frictional resistance: by using a ball bearing structure to convert the sliding friction into the rolling friction, the frictional force is reduced to 1/40 to 1/60 of the original sliding friction, thereby greatly improving the rotational flexibility of the hose reel, especially suitable for the use of heavy-loading hose reels;
2. balancing firmness and stability: the ball grooves on the bracket are processed using integrated molding technology, without the need for additional splicing, ensuring the overall structural strength of the bracket and achieving structural integration, avoiding the problem of decreased firmness caused by reduced contact area in existing solutions;
3. strong durability: the balls are made of POM material and arranged with the oil storage tank in the ball grooves to reduce friction loss, avoid rapid loss of lubricating oil, and extend the service life of the structure;
4. good maintainability: the design of the openable ball cover makes it easy for the user to add lubricating oil or replace balls in the future, thereby reducing maintenance costs and improving usability.

### BRIEF DESCRIPTION OF DRAWINGS

Below, a further detailed explanation of the present disclosure will be provided in combination with the accompanying drawings and specific implementation modes.

FIG. 1 is a structural schematic diagram of a hose reel.

FIG. 2 is a structural schematic diagram of a ball structure of a hose reel bracket.

FIG. 3 is a position structural schematic diagram of the hose reel bracket.

Numeral reference: hose reel 1, bracket 2, screw hole 21, ball groove 22, oil storage tank 221, side through hole 23, fixing component 3, through hole 31, ball overflow hole 32, ball 4, fixing plate 5.

### DESCRIPTION OF EMBODIMENTS

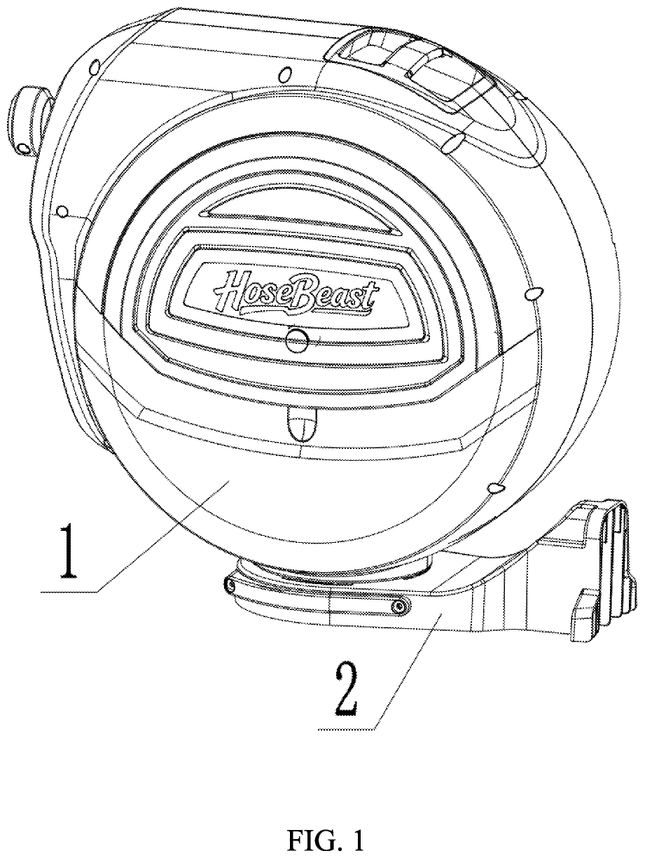

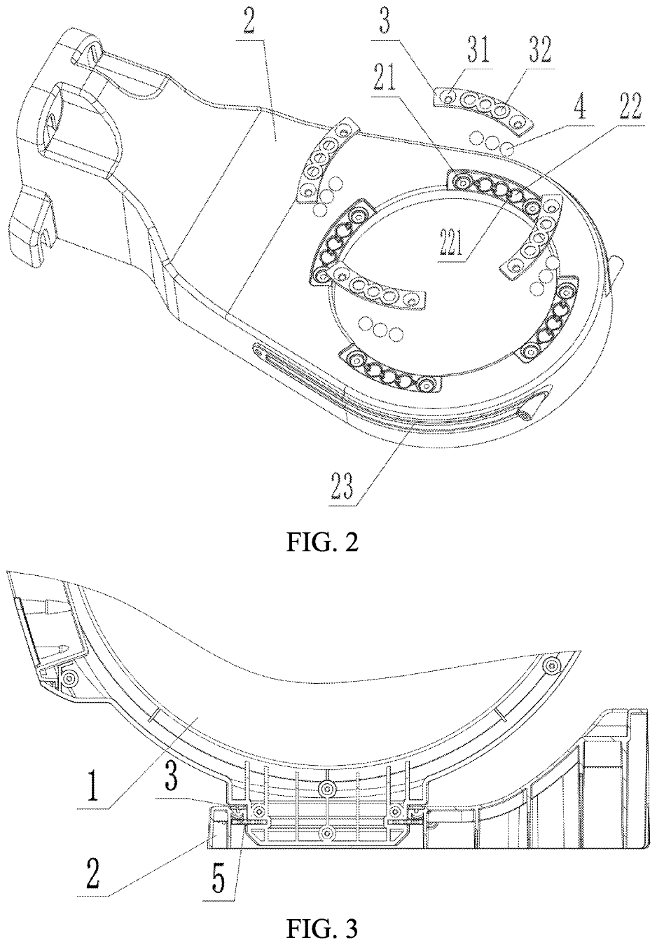

Referring to FIGS. 1-2, further detailed explanations of the present disclosure will be provided in combination with specific embodiments. It should be understood that specific embodiments described here are only for explaining the present disclosure and are not intended to limit it.

Referring to FIGS. 1-3, the ball structure of the hose reel bracket disclosed in the present disclosure is mainly used to solve problems of high rotational friction resistance, insufficient flexibility, and difficulty in balancing firmness between the existing hose reel and bracket. Its specific structure includes a hose reel 1, a bracket 2, a fixing component 3, balls 4, and a fixing plate 5. The structure, numbering correspondence, connection mode, and working principle of each component are described in detail below, and all part numbers are consistent with FIGS. 1-3.

The hose reel 1 is a conventional structure of the existing hose reel. As the core rotating component of this structure, its bottom surface is configured to contact the balls 4 to achieve a rotational action. The specific structure of the hose reel 1 (such as the pipeline winding mechanism) can be adapted according to actual usage needs. The present disclosure does not improve its own structure, only optimizes its connection and rotational fit structure with the bracket 2.

The bracket 2 serves as a load-bearing foundation of the entire structure, used to connect the hose reel 1 and the fixing component 3. It is processed using integrated molding technology and is preferably made of high-strength engineering plastic or aluminum alloy material, which not only ensures the structural strength of the bracket 2 itself, but also controls the overall weight and is suitable for installation and use in different scenarios. The bracket 2 is integrally formed with screw holes 21, ball grooves 22, and a side through hole 23, and these three structures work together to achieve stable connection between the bracket 2 and the fixing components 3, as well as the hose reel 1.

Where the ball grooves 22 are configured to accommodate the balls 4 and provide rotational space for the balls 4. Its molding process is completed synchronously with a main body of the bracket 2, without the need for additional splicing or welding, effectively avoiding the problems of easy loosening and insufficient strength at the splicing point. At the same time, it achieves structural integration, balancing firmness and lightweight. There are four ball grooves 22, and the four ball grooves 22 are evenly distributed along a circumference of the bracket 2. It is preferred to arrange them in a circular array with a center of the bracket 2 as a center. An angle between adjacent two ball grooves 22 is 90°. This distribution way can ensure that after the installation of the hose reel 1, its bottom surface can uniformly contact the balls 4 in each of the ball grooves 22. When the hose reel 1 rotates, the force is uniform, thereby avoiding problems such as deviation and jamming, significantly improving the rotational stability, especially suitable for the use of heavy-loading hose reels.

Each of the ball grooves 22 is provided with an oil storage tank 221, integrally formed at the bottom of the ball groove 22), which has an arc-shaped groove structure and is sized to match the ball grooves 22 for storing lubricating oil. In actual use, the lubricating oil in the oil storage tank 221 can continuously provide lubrication for the balls 4, thereby avoiding rapid loss of lubricating oil due to the rotation of the balls 4, reducing friction loss between the balls 4 and the ball grooves 22, and between the balls 4 and the bottom surface of the hose reel 1, further extending the service life of the balls 4 and the entire structure, and reducing maintenance frequency.

The screw holes 21 are provided on the bracket 2 at corresponding positions of the fixing component 3, with the same number as through holes 31 on the fixing component 3, used to cooperate with the screws to achieve detachable fixation between the fixing component 3 and the bracket 2; the side through hole 23 is provided on the side of the bracket 2 configured to insert the fixing plate 5. The bracket 2 is firmly fixed to the hose reel 1 through the fixing plate 5, ensuring the stability of the connection between the bracket 2 and the hose reel 1 and avoiding the displacement of the bracket 2 when the hose reel 1 rotates.

The balls 4 are provided in the ball grooves 22, with three balls 4 fixedly installed in each of the ball grooves 22. A diameter of each of the balls 4 is arranged to 8 millimeters, which has been optimized through multiple experiments. This size ensures that the balls 4 have sufficient load-bearing capacity to support the hose reel 1 (including the weight of the hose reel 1 itself and the weight of coiled pipeline), and also ensures that the balls 4 rotate flexibly in the ball grooves 22, without rotation jamming caused by large size or insufficient load-bearing and easy wear caused by small size. The balls 4 are made of POM (polyoxymethylene) material, which has excellent wear resistance, toughness, and self-lubricating performance. Compared with traditional metal balls, POM material balls can maintain good rotational performance without frequent lubrication, and have low self-friction loss, impact resistance, and are not easily deformed, suitable for long-term high-frequency rotation needs.

The fixing component 3 is used to limit and fix the balls 4, thereby preventing the balls 4 from detaching from the ball grooves 22 without affecting a normal rotation of the balls 4. The fixing component 3 includes a PP (polypropylene) plastic ball cover and two screws. The PP plastic ball cover is made of food-grade PP material, which is lightweight, corrosion-resistant, and has good toughness. It will not cause wear to the balls 4 and can avoid rusting problems (compared to metal fixing parts). The fixing component 3 is provided with through holes 31 and ball overflow holes 32. There are two through holes 31, symmetrically distributed at two ends of the fixing component 3, corresponding one-to-one with the screw holes 21 on the bracket 2; a size of each of the ball overflow holes 32 is slightly smaller than the diameter of each of the balls 4, ensuring that a part of the balls 4 can overflow from the ball overflow holes 32 and make contact with the bottom surface of the hose reel 1, while avoiding the balls 4 from falling off from the overflow holes.

The specific fixing way between the fixing component 3 and the bracket 2 is as follows: the two screws are threaded through the two through holes 31 on the fixing component 3, and connected to the corresponding screw holes 21 on the bracket 2. After tightening the screws, the fixing component 3 can be firmly closed to an opening of the ball grooves 22, and the balls 4 can be limited and fixed. At this time, a part of the balls 4 overflow from ball overflow holes 32, just in contact with the bottom surface of the hose reel 1, ensuring that the bottom surface of the hose reel 1 does not directly contact the surface of bracket 2. In an implementation mode, the fixing component 3 (PP plastic ball cover) is arranged as an openable structure, which can be fixed with a snap-connection way with aid of auxiliary screws or a flipped structure. When maintenance of the balls 4 is required, only two screws need to be unscrewed to open the fixing component 3, rendering it easy to add lubricating oil to the oil storage tank 221 in the ball grooves 22 or replace worn or damaged balls 4. The operation is convenient, achieving maintainability of the entire structure, reducing subsequent maintenance costs, and extending the overall service life.

The fixing plate 5 is a long strip structure, and its size is adapted to the side through hole 23 on the bracket 2. After passing through the side through hole 23, the fixing plate 5 is fixedly connected to the corresponding positions of the hose reel 1 at two ends, thereby firmly the fixing the bracket 2 on the hose reel 1, ensuring the relative stability of the bracket 2 and the hose reel 1, avoiding the bracket 2 from shaking or shifting when the hose reel 1 rotates, and further improving the stability of the entire structure.

The working process of the present disclosure is as follows: firstly, the assembly of each component is completed. The balls 4 are placed into the ball grooves 22 of the bracket 2, and an appropriate amount of lubricating oil is added to the oil storage tank 221. The fixing component 3 is covered at the opening of the ball groove 22, and two screws are passed through the through holes 31 and the screw holes 21 to fix the fixing component 3 and the bracket 2. At this time, a part of the balls 4 overflows from the ball overflow holes 32; then the fixing plate 5 passes through the side through hole 23 on the bracket 2, and the bracket 2 is fixed on the hose reel 1, ensuring that the bottom surface of the hose reel 1 is fully in contact with the overflow part of the balls 4, and that the bottom surface of the hose reel 1 does not directly contact the surface of the bracket 2.

When the user rotates the hose reel 1, relative motion occurs between the bottom surface of the hose reel 1 and the ball 4. As the balls 4 can freely rotate in the ball grooves 22, the balls 4 will cooperate with the hose reel 1 to rotate together, converting the original sliding friction between the hose reel 1 and the bracket 2 into rolling friction. Through actual testing, this structure can reduce the friction force to 1/40 to 1/60 of the original sliding friction scheme, greatly reducing the rotational resistance and rendering the hose reel 1 rotate more flexibly and smoothly. Even heavy-loading hose reels can easily achieve rotational operation.

During long-term use, the lubricating oil in the oil storage tank 221 can continuously provide lubrication for the balls 4, reducing friction losses; when the lubricating oil is insufficient or the balls 4 are worn, the screws can be unscrewed to open the fixing component 3 and perform the operation of adding lubricating oil or replacing the balls 4, which is convenient for maintenance. At the same time, the ball grooves 22 on the bracket 2 are integrally formed, and the four ball grooves 22 are evenly distributed, which, together with the fixing effect of the fixing plate 5, ensures the firmness and rotation stability of the connection between the hose reel 1 and the bracket 2, effectively solving the problems of high friction resistance, insufficient flexibility, and difficulty in balancing firmness in the existing technology.

The above description is only a preferred embodiment of the present disclosure and is not intended to limit the protection scope of the present disclosure. Any modifications, equivalent substitutions, improvements, etc. made within the spirit and principles of the present disclosure shall be included within the protection scope of the present disclosure.

What is claimed is:

1. A ball structure for a hose reel bracket, comprising: a bracket and a hose reel,
wherein ball grooves are integrally formed on the bracket, and balls are arranged in the ball grooves; the balls are fixed in the ball grooves by a fixing component, and a bottom surface of the hose reel bracket does not directly contact a surface of the bracket, but contacts the balls;
wherein when rotating, the balls rotate in cooperation and convert a sliding friction between the hose reel bracket and the bracket into a rolling friction.

2. The ball structure for a hose reel bracket according to claim 1, wherein there are four ball grooves, and the four ball grooves are evenly distributed on the bracket.

3. The ball structure for a hose reel bracket according to claim 1, wherein an oil storage tank is provided in the ball grooves for storing lubricating oil to reduce lubricating oil loss.

4. The ball structure for a hose reel bracket according to claim 1, wherein three balls are provided in each of the ball grooves, and each of the balls has a diameter of 8 millimeters.

5. The ball structure for a hose reel bracket according to claim 1, wherein the balls are made of polyoxymethylene, (POM) material.

6. The ball structure for a hose reel bracket according to claim 1, wherein the fixing component comprises a polypropylene, (PP) plastic ball cover and screws, and there are two screws,
wherein the ball cover is fixed to the bracket by the screws to limit and fix the balls.

7. The ball structure for a hose reel bracket according to claim 1, wherein the ball cover is configured to be opened for adding lubricating oil or replacing the balls, thereby achieving maintainability of the structure.
